(19) United States
(12) Patent Application Publication
(10) Pub. No.: US 2007/0074281 A1
(43) Pub. Date: Mar. 29, 2007

(54) Presence-base packet routing control apparatus and packet routing control method

(75) Inventor: Hiroki Ikeda, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/495,539

(22) Filed: Jul. 31, 2006

(30) Foreign Application Priority Data
Sep. 23, 2005 (CN) 200510106901.X

(51) Int. Cl. H04L 9/00; G06F 15/16; G06F 17/00; H04K 1/00; G06F 9/00

(52) U.S. Cl. 726/13; 726/1; 726/14

(57) ABSTRACT

A presence-base packet routing control apparatus having a presence policy management data base for indicating routing policies in association with user terminal's presence statuses analyzes presence information notified from a user terminal, translates the presence information into a presence status of the user terminal, searches the presence policy management data base for a routing policy corresponding to the presence status of the user terminal, and issues a command to install the routing policy in a particular router to which the user terminal is connected.

### CLAIM OF PRIORITY

The present application claims priority from Chinese Patent application serial No. CN 200510106901.X, filed on Sep. 23, 2005, the content of which is hereby incorporated by reference into this application.

### BACKGROUND OF THE INVENTION

(1) Field of the Invention

The present invention relates to a packet routing control apparatus and a packet routing control method. More particularly, the invention relates to a packet routing control apparatus and packet routing control method by which a routing policy appropriate for user's presence information is dynamically installed in a particular router in a communication network for transferring IP packets, and to an associated network communication system.

(2) Description of Relate Art

Communication techniques using a user status management technique which is called a presence method have heretofore been developed in a wide range. The so-called presence method is a technique for detecting the current status of a user terminal, managing such status as presence information, and notifying a requester of the presence information, compliant with a standardization document, Request for Comments (RFC) 3265 which has been created by the Internet Engineering Task Force (IETF) and published by the Internet Architecture Board (IAB). The presence method is applied, for example, to a Session Initiation Protocol (SIP) standardized in RFC 3261 to transmit and receive presence information. By notification of some user's presence information to other users or nodes in a real time manner, each user can know the current status information of a peer terminal in communication with each other.

As one of notification services of peer's presence information, there is an instant messaging service standardized in RFC 2778 and RFC 2779. By this instant messaging service, a mechanism of knowing peer's status such as, for example, whether the peer's terminal has logged in, is established so that each user can communicate with each other, while making sure of the peer's presence status.

Here, the presence information means information representing a physical status detectable for a user terminal and the presence status means a terminal's logical status that can be obtained by analyzing the presence information. In the present specification, the presence information and the presence status have the following relationship. For instance, when a user terminal's presence information indicates “online”, its associated presence status is “present at office”, and when the presence information indicates “offline”, its associated presence status is “present at home.” The presence information may be information indicating a physical location of a user terminal measured by, for example, GPS or the identifier of a wireless base station to which a mobile terminal is being connected or the prefix of a care of address. In this case, the terminal location information is translated into the presence status of a class such as “present at office” or “present at home”.

Recently, a presence server for centralized management of presence information has been developed. By centralized management of presence information, the efficiency of management is improved. Services using the presence server now begin to diversify. One type of presence information service is a location information service through interoperation with latest mobile terminals.

Meanwhile, a policy routing approach is applied in a packet network. The policy routing approach is used to route packets in a network according to different policies defined separately for, for example, different telecoms companies and Internet Service Providers (ISPs).

As control schemes in a packet network, which are specific to each of network service providers such as telecoms companies, there are a Quality of Service control scheme and a routing control scheme. In general packet routing, a router determines an output destination port for a received packet based on the destination IP (Internet Protocol) address included in the header of the received packet. In contrast, in the routing control scheme, the router determines an output destination port of a received packet in accordance with a packet flow, using other header information besides the IP address of destination terminal, for example, an IP address of source terminal, a TCP/UDP port number, a priority value (Diffserv Code Point: DSCP), etc. By reconfiguring the routing control scheme (policies) to be applied to the router, each network service provider can adopt policy routing for effective transfer of IP packets.

A router having the policy routing function is associated with a policy server for a unified management of routing policies. As a typical example of a protocol by which the policy server controls the router, a Common Open Policy Service (COPS) protocol standardized in RFC 2748 is known. By installing policies associated with, for example, TCP/UDP port numbers and applications to the router, the router is able to route IP packets to different routes for different applications.

The router provided with the policy routing function is able to implement priority control by which packets of a particular class are given transfer preference according to the policies classified into a plurality of priority control classes. In this case, a DSCP value corresponding to one of the above priority control classes is set in the header of every packet received by the router. Each relying router deployed in the network forwards a packet in which a DSCP value has been set to the next-hop node in the priority order of the DSCP value, according to a predetermined rule. Preferential transfer control of packets using the DSCP values is called Differentiated Services (Diffserv). These policy routing approaches are utilized in transfer of real-time packets (voice packets and video packets) for which it is necessary to minimize a transmission delay on the network, for example, for IP telephony.

However, in an environment like a mobile network where user location status frequently changes, if a method of installing such application policies different for each user as voice IP communication, video IP communication, and the like, in each router beforehand is used, it will increase the burdens on the telecoms companies. Think about a method of installing routing policies per application on a user-by-user basis in all routers beforehand, regardless of the presence status for each user such as the current location of a user. This will increase the load on each router and a delay in relaying real-time packets. Furthermore, this will increase the load for routing policy installation along with a growing scale of IP networks and an increase in the number of network users.

In the prior art, it is impossible to install in a router in real time an appropriate routing policy for a real-time application such as voice IP communication depending on the situation. Because a prior-art presence server does not have a policy control unit, the presence server is unable to directly control the QoS and routes of packets at each router.

For example, as shown in FIG. 11, in a case where a presence server 100 which comprises a presence information analyzing unit 100 and a presence information management data base 170 and a policy server 101 which comprises a router control unit 130, a policy management data base 161, and router information management data base 170 exist independently of each other, when a change in the presence status of a mobile terminal (user) occurs, the policy server 101 cannot detect that change. Therefore, instead of the policy server 101, an operator has to install policies in the router 30 according to mobile terminal status change. However, as the network scale grows, those events that require policy reconfiguration will occur frequently and, consequently, is becomes hard to respond in such a manual installation manner by the operator.

### SUMMARY OF THE INVENTION

In the future, when the fourth-generation mobile integrated network and mobile IP network will become widely used, there will emerge an environment where an optimum network to be used for packet transfer can be selected from among many networks. For instance, it will become feasible that a user simultaneously uses a plurality of networks such as a mobile network, Internet, a wireless LAN. For instance, in a mobile IP network, a user will become able to move, while holding a same IP address. However, in the current IP network, since a packet route is determined based on the destination IP address, source IP address, and a port number of the packet received, it is impossible to select an optimum network according to the presence status of a user. To enable the selection of a network according to the presence status of a user, the operator of the policy server has to install an IP packet routing policy for each router according to a change in the user status. However, under the mobile network environment where user status frequency changes, it is hard to realize such manual installation of a routing policy by the operator.

An object of the present invention is to provide a packet routing control apparatus and a packet routing control method capable of automatic installation of a routing policy for a router and a route selection according to the current status of a user terminal in a packet network.

Another object of the present invention is to provide a packet routing control apparatus and a packet routing control method capable of preventing a delay in relaying packets in a packet network and an increase in the load on a node.

To achieve the above objects, a presence-base packet routing control apparatus according to the present invention is provided with a presence policy management data base for indicating the correspondence of user terminal's presence statuses with routing policies, analyzes presence information when the presence information is notified from a user terminal, translates it into a presence status of the user terminal, searches the presence policy management data base for a routing policy corresponding to the presence status of the user terminal, and issues a command to install the routing policy in a particular router to which the user terminal is connected.

More specifically, the presence-base packet routing control apparatus according to the present invention comprises:

a presence information management data base for storing presence status information for each user terminal;

a presence policy management data base for storing routing policies to be applied for the user terminal in association with possible presence statuses of a user terminal;

a presence information analyzing unit for translating presence information notified from a user terminal into presence status information and updating the presence information management data base, as required, according to the presence status information; and

a presence-base routing policy control unit for determining a routing policy to be installed in a particular router to which the user terminal is connected, based on the presence status of the user terminal output from the presence information analyzing unit and information stored in the presence policy management data base.

In an embodiment of the present invention, the presence-base packet routing control apparatus further comprises a router control unit for creating a routing policy installation command based on the routing policy determined by the presence-base routing policy control unit, and transmitting the routing policy installation command to the particular router to which the user terminal is connected.

A packet routing control method according to the present invention comprises the steps of:

transmitting from a user terminal to a packet routing control apparatus a message specifying presence information of the user terminal;

analyzing by the packet routing control apparatus, the presence information specified in the message received and determining the user terminal's presence status;

determining by the packet routing control apparatus according to the presence status of the user terminal, a routing policy to be applied for packets received from the user terminal;

creating by the packet routing control apparatus, a routing policy installation command for the determined routing policy and transmitting the command to a particular router to which the user terminal is connected; and

changing by the particular router, routing conditions to be applied for packets received from the user terminal according to the routing policy installation command.

### BRIEF DESCRIPTION OF DRAWINGS

FIG. 1 is a functional block diagram of a presence-base packet routing control apparatus to which a packet routing control method of the present invention is applied.

FIG. 2 is a diagram to explain an example of operation of a communication network in which the packet routing control method of the present invention is applied.

FIG. 3 is a diagram to explain another example of operation of the communication network in which the packet routing control method of the present invention is applied.

FIG. 4 is a flowchart of routing control operation to be performed by the packet routing control apparatus of the present invention.

FIG. 5 shows the structure of a presence information management data base 150 provided in the packet routing control apparatus of the present invention.

FIG. 6 shows the structure of a presence policy management data base 160 provided in the packet routing control apparatus of the present invention.

FIG. 7 is a sequence chart illustrating the internal operation of the packet routing control apparatus of the present invention.

FIG. 8 shows the structure of router information management data base 170 provided in the packet routing control apparatus of the present invention.

FIG. 9A is a diagram to explain a further example of operation of a communication network in which the packet routing control method of the present invention is applied; and FIG. 9B is a diagram to explain the structure of a presence policy management data base.

FIG. 10A is a diagram showing a still further example of operation of the communication network in which the packet routing control method of the present invention is applied; and FIG. 10B is a diagram showing the structure of a presence policy management data base.

FIG. 11 shows the block diagrams of a presence server and a policy server according to prior art.

### DETAILED DESCRIPTION OF PREFERRED EMBODIMENTS

An embodiment of the present invention will be described, by way of example, in a case where VoIP is used as an application, a Session Initiation Protocol (SIP) is used for a call control protocol between user terminals, and a Command Line Interface (CLI) is used as a policy installation protocol. However, it is not necessarily the case that the suite of these protocol is the most suitable for effecting the invention.

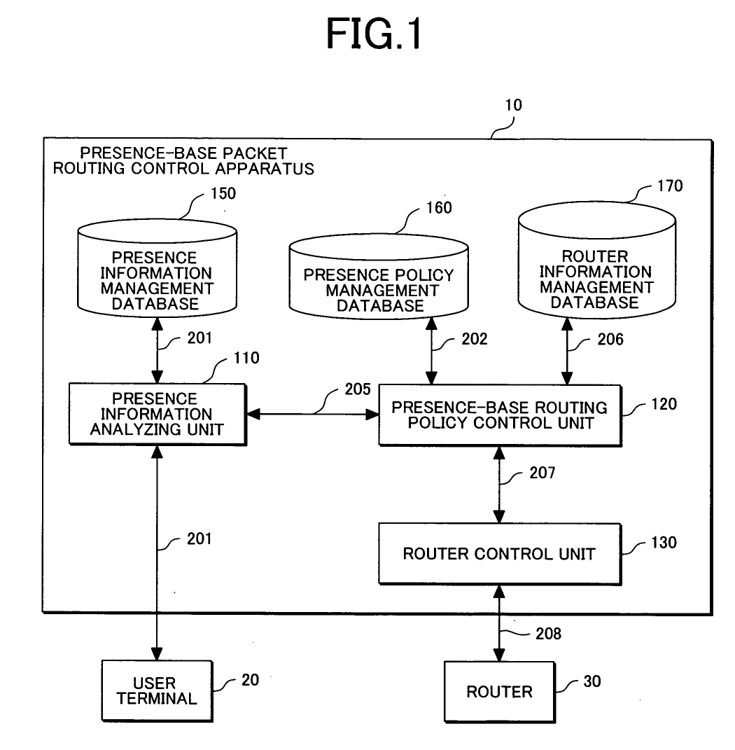

FIG. 1 shows a block diagram of a presence-base packet routing control apparatus 10 to which a packet routing control method of the present invention is applied.

The packet routing control apparatus 10 of the present invention is provided with a presence information management data base 150 for storing presence management information 201 for a plurality of user communication terminals, a user presence policy management data base 160 for storing user presence policy information 202 representing the correspondence of user presence statuses with routing policies which meet user demands, a router information management data base 170 for storing router management information representing the correspondence of router connection information (router identifier) with routing status information entries each indicating routing policy for each user terminal connection information (terminal identifier). In the router information management data base 170, general network configuration information is also stored in addition to the above router management information.

The packet routing control apparatus 10 further includes a presence information analyzing unit 110 for analyzing and relaying the presence information 201, a presence-base routing policy control unit 120 for determining a routing policy 207 to be applied to the communication between user terminals, based on presence information analysis result 205 output from the presence information analyzing unit 110, user presence policy information 202 read out from the data base 160 and network configuration information read out from the router information management data base 170, and a router control unit 130 which creates a routing policy installation command 208 based on the routing policy 207 determined by the presence-base routing policy control unit 120 and information stored in the router information management data base 170. The router control unit 130 transmits the routing policy installation command to a router in which the routing policy should be installed.

Here, in the presence policy management data base 160, presence policy information for each user is set beforehand in the initial state. In the router information management data base 170, plural pieces of router connection information, for example, router identifiers for a plurality of routers to which routing policy installation should be performed are set beforehand.

In the above presence-base packet routing control apparatus 10, the presence information analyzing unit 110 updates the presence information stored in the presence information management data base 150, according to presence information notified from a user terminal 20. The presence information analyzing unit 110 analyzes the presence information and checks the user's presence status. If the presence status has changed, the presence information analyzing unit 110 creates presence information analysis result 205 indicating the current presence status and sends this result to the presence-base routing policy control unit 120. The presence-base routing policy control unit 120 creates a routing policy 207 to be installed in the router 30 based on the presence information analysis result 205 and information stored in the presence policy management data base 160, and referring to the network configuration information stored in the router information management database 170, if necessary. The router control unit 130 specifies the adores of the router 30 in which the above routing policy should be installed by referring to the network configuration information stored in the router information management data base 170 and transmits a routing policy installation command 208 generated in accordance with the routing policy 207 to the router 30 through the use of the CLI.

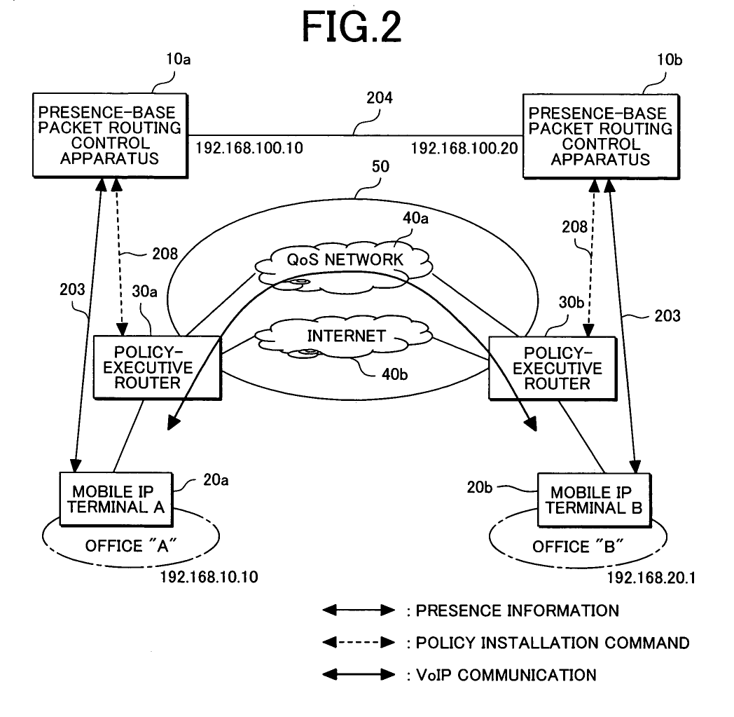

FIG. 2 is a diagram to explain an example of application of the packet routing control method of the present invention to an IP network in which policy routing is executable.

Here, explanation will be given, by way of example, in a case where voice communication is performed between mobile IP terminals. However, it is not necessarily the case that the invention is effected in such voice communication.

First, the network configuration is described. Voice communication is performed between a mobile IP terminal 20a having an IP address of “192.168.10.1” and a mobile IP terminal 20b having an IP address of “192.168.20.1” via the IP network 50 in which policy routing is executable. Here, it is assumed that the mobile IP terminal (user A) 20a and the mobile IP terminal (user B) 20b are located at office A and office B, respectively.

The IP network 50 comprises a QoS network 40a having the function of packet delay assurance and a general Internet 40b where packet delay is not assured. To these networks 40a and 40b, policy-executive routers 30a and 30b are connected. The policy-executive routers 30a and 30b are managed by presence-base packet routing control apparatuses 10a and 10b, respectively. The association between the presence-base packet routing control apparatuses 10a and 10b and the policy-executive routers 30a and 30b is determined based on the network scale and network management policies or the like.

The mobile IP communication terminal 20a transmits a control message for reporting its presence information to the packet routing control apparatus 10a having a pre-assigned IP address of “192.168.100.10” when communicating with the mobile IP communication terminal 20b. In order to notify the packet routing control apparatus 10a of the presence information from the terminal 20a, for example, a REGISTER message as prescribed by RFC 3265 can be used.

Upon receiving the presence information transmitted from the mobile IP communication terminal 20a, the packet routing control apparatus 10a sends this information to another packet routing control apparatus 10b having an IP address of “192.168.100.20.” At this time, both the packet routing control apparatuses 10a and 10b analyze the received presence information and determine the presence status of the mobile IP communication terminal. The packet routing control apparatuses 10a and 10b update their presence information management data bases, if necessary, and determine a routing policy based on the presence policy management data bases 160.

Here, since the presence status of the mobile IP communication terminal 20a indicates that the terminal's user is at office A, the packet routing control apparatus 10a determines that voice packets for the mobile IP communication terminal 20a should be communicated through the QoS network 40a. The correspondence of the presence status with the policy to be applied is stored beforehand in the presence policy management database 160. The packet routing control apparatus 10a specifies the policy-executive router 30a having the IP address “192.168.100.1” to which the communication terminal 20a is now being connected from the router information management data base 170 and transmits the routing policy for the mobile IP communication terminal 20a to the policy-executive router 30a, using the CLI.

The packet routing control apparatus 10b transmits the routing policy for the mobile IP communication terminal 10b to the policy-executive router 30b having the IP address “192.168.100.2” through the use of the CLI in a similar manner as the packet routing control apparatus 10a does. As a result, voice packets that are communicated between the mobile IP communication terminals 20a and 20b are transferred via the QoS network 40a having the function of voice delay assurance and, accordingly, the quality of the voice communication service between the mobile IP terminals can be guaranteed.

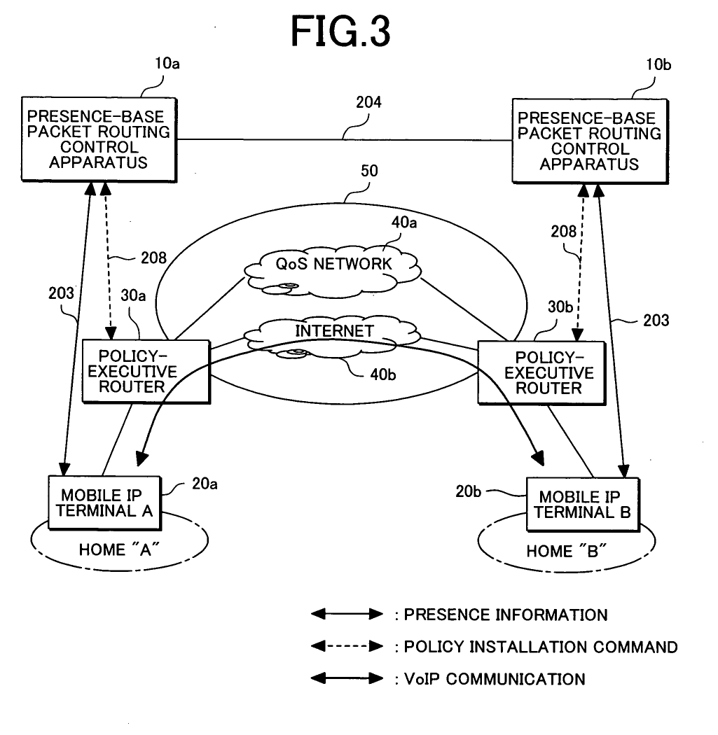

FIG. 3 is a diagram to explain another example of operation of the IP network in which the packet routing control method of the present invention is applied.

The network configuration is the same as shown in FIG. 2. However, this example assumes that the mobile IP terminals 20a and 20b are located at home (home A and home B), respectively. In the case like this where mobile IP communication terminals are located at home, a presence policy is set beforehand in the presence policy management data base 160 so that voice communication is performed via the Internet 40b. When the mobile IP terminals 20a and 20b start voice communication, a routing policy is installed in the policy-executive routers 30a and 30b by the same routing policy installation operation as illustrated in FIG. 2 so that voice IP packets between the mobile IP terminals 20a and 20b are communicated via the Internet 40b. As a result, it is able to provide voice communication service between the mobile IP terminals at a low price. Thus, by applying the packet routing control method of the present invention, the routers (policy-executive routers) is enabled to make a rout setting and a network selection appropriate for the communication terminals' presence status (whether the current location is at office or home), even if the users make use of the same communication service, VoIP in the above example.

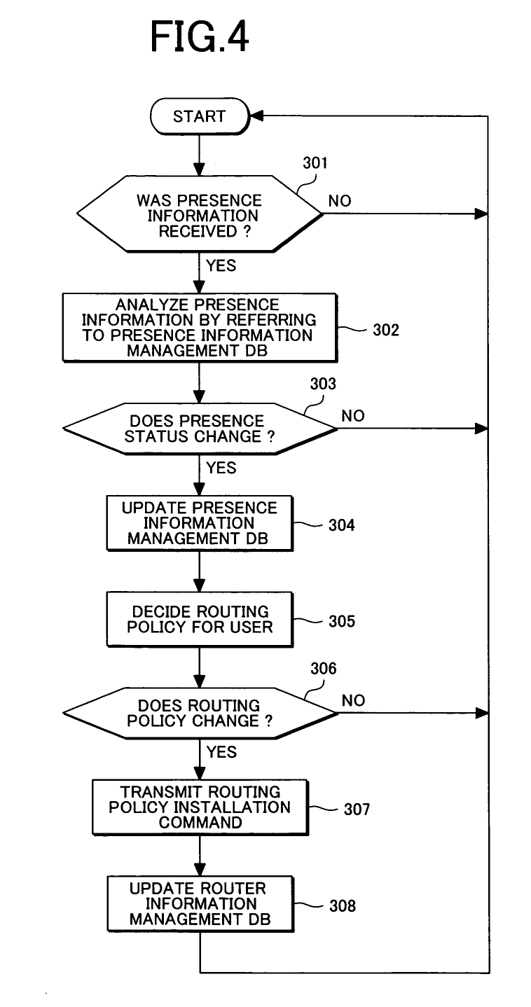

FIG. 4 shows a flowchart of routing control operation to be performed by the packet routing control apparatus 10 (10a, 10b) of the present invention. Here, the packet routing control method of the present invention is explained with reference to the components of the presence-base packet routing control apparatus 10 shown in FIG. 1.

First, the presence information analyzing unit 110 determines whether a presence information message has been received from a user terminal (step 301). If a presence information message has been received, the presence information analyzing unit 110 analyzes the current presence information by referring to the presence information management data base 150 (step 302). The presence information message includes besides the address and the current location information of the source user terminal, a source port number and the address of the peer terminal. The presence information message may include the presence information of the peer terminal, if necessary.

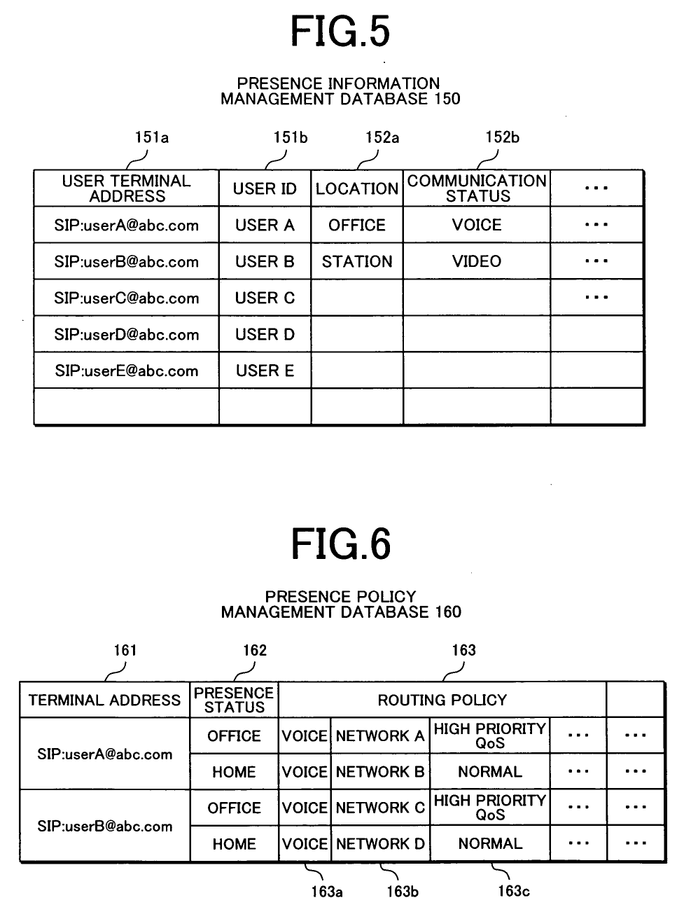

In the presence information management data base 150, a plurality of presence management information entries each indicating presence information 152 in association with user terminal information 151 are stored, for example, as shown in FIG. 5. In the present embodiment, the user terminal information 151 includes a terminal address 151a expressed by using SIP ULR and a user ID 151b of the terminal's owner. The presence information 152 includes presence status 152a of the user terminal (mobile IP communication terminal), current communication status 152b of the mobile IP communication terminal, and other items.

In the presence management information entry, any other terminal identifier such as IP address may be used as the terminal address 151a, instead of SIP ULR. Other information items of the presence information 152 may include, for example, information corresponding to the current location of the user terminal. Translation from the current location information of the user terminal into the presence status 152a is performed in accordance with a translation table not shown. The first entry shown in FIG. 5, for example, specifies that the communication terminal has the terminal address “SIP: userA@abc.com”, its owner user ID is “User A”, the current presence status is “office”, and communication status is “voice”.

Reference to the presence information management data base 150, which is performed in step 302, means searching for a presence management information entry having a value as the terminal address 151a matched with the terminal address specified in the presence information message. The presence information analyzing unit 110 then determines whether the presence status 152a of the user terminal has changed (step 303). When the presence status has changed, the presence information analyzing unit 110 updates the relevant presence status 152a in the presence information management data base and sends the contents of the presence management information entry including a new presence status and the contents of the present information message to the presence-base routing policy control unit 120 as presence information analysis result (step 304).

The presence-base routing policy control unit 120 decides a routing policy for the user based on the information sent from the presence information analyzing unit 110, routing policy information stored in the presence policy management data base 160 and network configuration information stored in the router information management server 170 (step 305) and determines whether the routing policy has changed by referring to routing status information stored in the router information management data base 170, if necessary (step 306).

The presence policy management data base 160 is referred to for determining an optimum routing policy depending on the user's presence status. In this data base, a plurality of entries are registered, each entry representing a routing policy 163 for each presence status 162 in association with a terminal address 161, for example, as shown in FIG. 6. In the embodiment shown here, the terminal address 161 is expressed by SIP URL (Uniform Resource Locator) and the presence status 162 represents the current status of the user terminal as one of status classes which are the same as for the presence status 152a shown in FIG. 5. The routing policy 163 is defined by transmission data attribute 163a, network identifier to be selected 163b, QoS required (priority information: DSCP value) 163c, and other information items.

For example, the first entry shown in FIG. 6 indicates that, for the communication terminal with “SIP:userA@abc.com” as the SIP URL value, voice data packets should be routed to network A at high priority if the presence status is “office” and routed to network B at normal priority if the presence status is “home”.

If the routing policy to be installed in the router has changed due to a change in the presence status of the user terminal, the presence-base routing policy control unit 120 sends a new routing policy to the router control unit 130. Upon receiving the new routing policy, the router control unit 130 creates a routing policy installation command and transmits this command to the router (step 307). After that, the router control unit 130 updates the routing status information in the router information management data base (step 308). The address of the router to which the routing policy installation command should be transmitted is specified from the network configuration information stored in the router information management data base 170.

In the presence policy management data base 160, the routing policy 163 may designate traffic by a combination of, for example, source terminal IP address, destination terminal IP address, and source port number. Instead of the network identifier 163b, the identification number of an output interface of the policy-executive router to be connected to the network may be used.

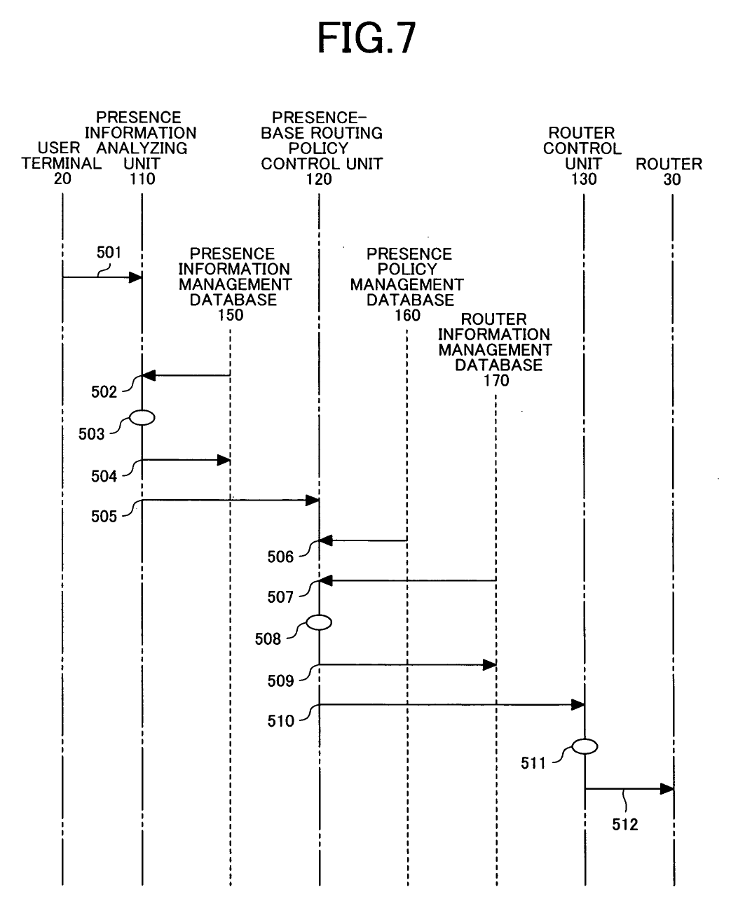

FIG. 7 is a sequence diagram illustrating the internal operation of the presence-base packet routing control apparatus 10 according to the present invention.

A presence information message transmitted from a mobile IP communication terminal 20 is received by the presence information analyzing unit 110 which is one of components of the packet routing control apparatus 10 (step 501). The presence information analyzing unit 110 searches the presence information management database 150 for the presence management information for the communication terminal 20 based on the received presence information message (step 502), and analyzes the received presence information and determines the current presence status of the communication terminal 20 (step 503). Here, the presence information comprehensively means information translatable into presence status, such as the current location of the terminal (mobile IP communication terminal) 20 and the operation mode of a communication facility that the user utilizes (online/offline).

As the result of presence information analysis, if it is found that the presence status has changed, the presence information analyzing unit 110 updates the content of relevant entry in the presence information management data base 150 (step 504) and sends the presence information analysis result to the presence-base routing policy control unit 120 (step 505).

Having received the presence analysis result, the presence-base routing policy control unit 120 searches the presence policy management data base 160 for routing policy information corresponding to the user terminal 20 (step 506), searches the network configuration information stored in the router information management data base 170 for an identifier and configuration information of the policy-executive router corresponding to the user terminal 20 (step 507), and determines the routing policy to be installed in the router (step 508). The presence-base routing policy control unit 120 updates the routing status information in the router information management data base in accordance with the new routing policy (step 509) and sends the new routing policy to the router control unit 130 (step 510). The router control unit 130 creates a routing policy installation command (step 511) and transmits this command to the router 30 to which the user terminal 20 is connected (step 512). However, the step 509 may be executed by the router control unit 130.

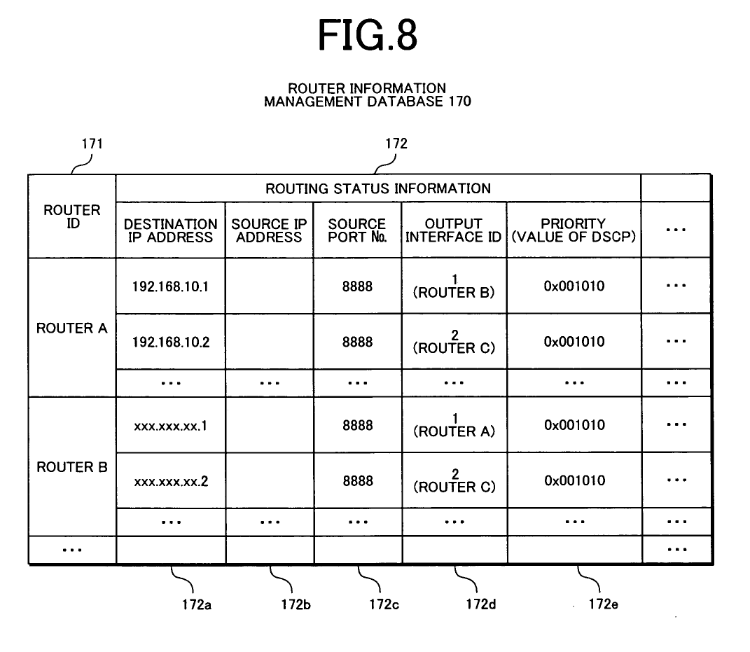

FIG. 8 shows an example of the structure of the router information management data base 170.

The router information management data base 170 stores routing status information for each call connection in association with the connection information of each router on the IP network. Besides the above information, general network configuration information is also stored in the router information management data base 170.

In the present embodiment, the router connection information is expressed by a router ID 171 and the routing status information 172 includes information items such as a destination terminal IP address 172a, a source terminal IP address 172b, a source port number 172c, an output interface ID 172d, and DSCP value 172e indicative of a priority of IP packet transfer.

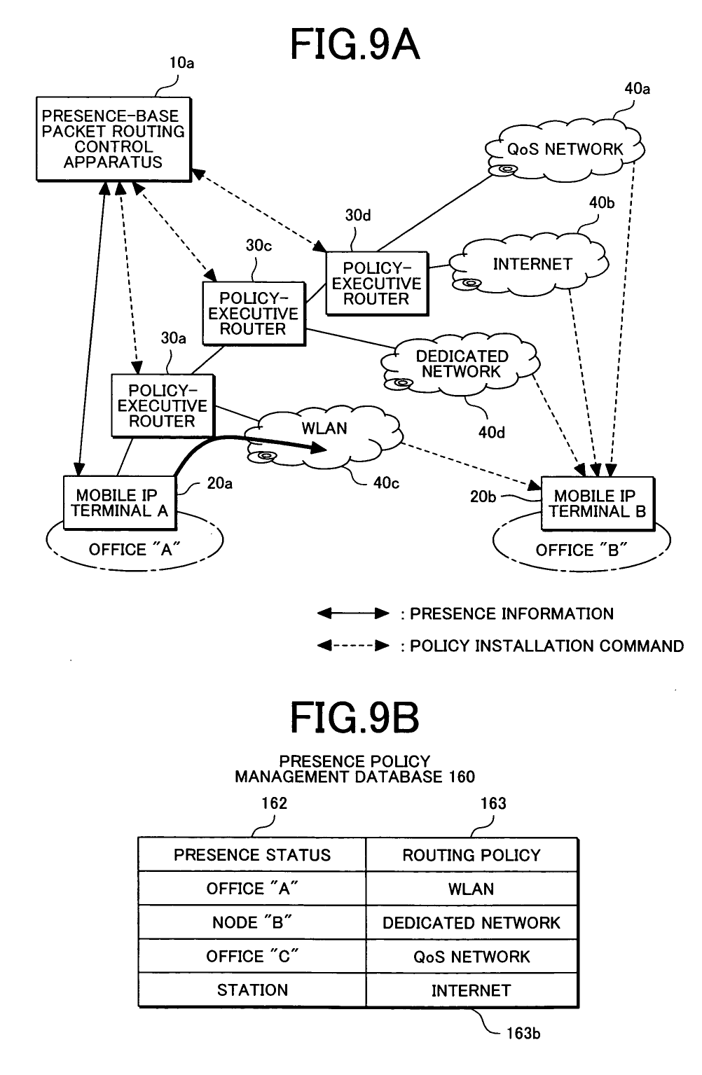

FIG. 9A shows a further example of operation of a communication network in which the packet routing control method of the present invention is applied.

In the network shown here, a plurality of policy-executive routers 30a, 30b, 30c are connected in multiple stages so that a user terminal (mobile IP terminal) 20a can be selectively connected to one of a plurality of different type networks 40a to 40d via the policy-executive routers.

The presence-base packet routing control apparatus 10a setup a route for transferring IP packets according to presence information from the mobile IP terminal 20a. In the present embodiment, the user terminal's location information is used as the presence information. In the presence policy management data base 160, network types 163b are defined as routing policies 163 corresponding to the presence statuses 162 of the source terminal, as shown in FIG. 9B. For example, if the mobile IP terminal 20a is located at “office A,” the presence-base packet routing control apparatus 10a selects the WLAN 40c based on the presence policy management data base 160, and installs the routing policy in a policy-executive router 30a so that the policy-executive router 30a connected to the WLAN 40c will transfer packets received from the mobile IP terminal 20a to the network WLAN 40c.

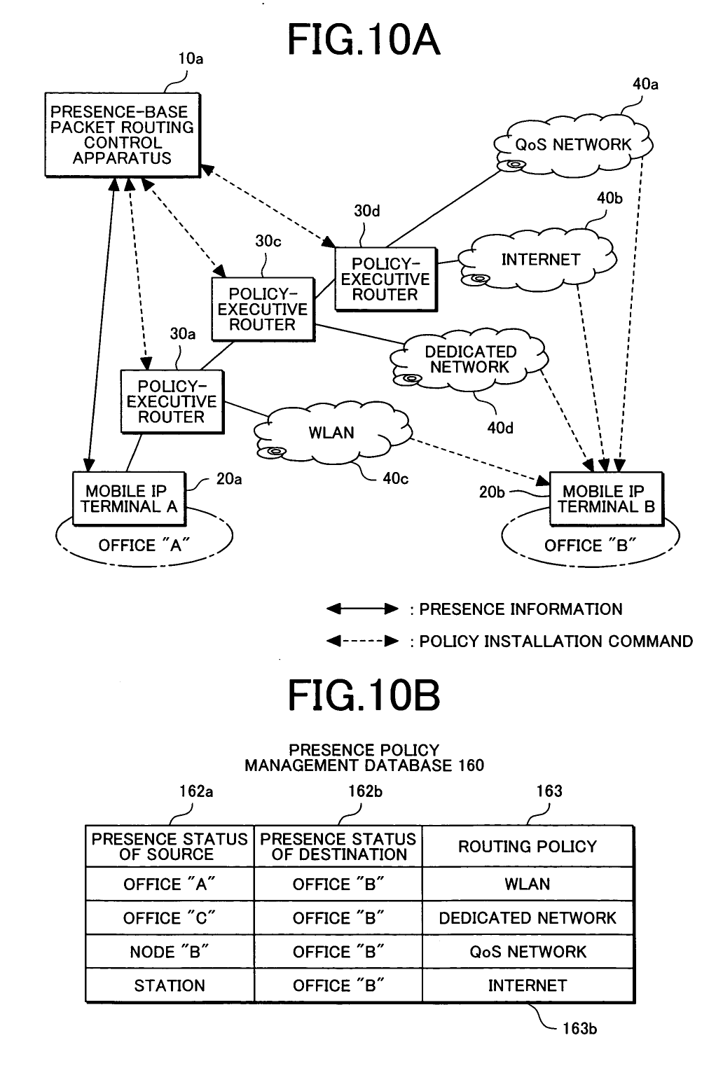

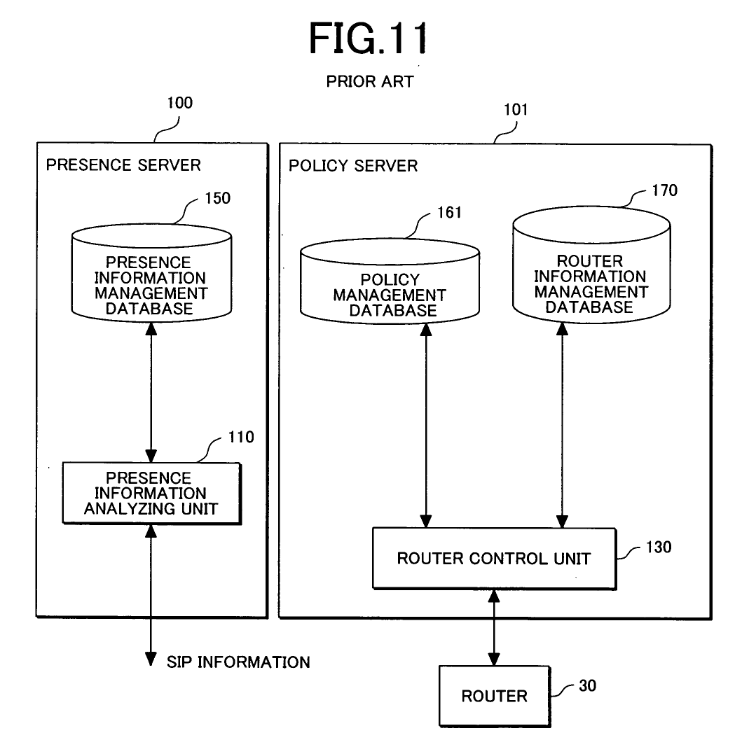

FIG. 10A shows a still further example of operation of the communication network in which the packet routing control method of the present invention is applied.

The network configuration comprises a plurality of presence policy-executive routers connected in multiple stages, similarly to the network shown in FIG. 9A. In the present embodiment, the presence policy management data bases 160 defines a network type to be selected as routing policy 163 in association with the combinations of source terminal's presence statuses 162a and destination terminal's presence statuses 162b.

In the present embodiment, location information is used as presence information. For example, if the source mobile IP terminal 20a is located at “office A” and the destination mobile IP terminal 20b is located at “office B”, the presence-base packet routing control apparatus 10a installs a routing policy in the policy-executive router 30a so that IP packets from the mobile IP terminal 20a to the mobile IP terminal 20b will be transferred through the network WLAN. By designating packet type 163a with the routing policy 163 as the presence policy management data base shown in FIG. 6, it is able to select a network appropriate for user terminal's presence information and communication data type.

As apparent from the foregoing description, the present invention enables packet transfer so as to reduce a delay time in relaying packets and waste of network resources in an IP network capable of policy routing of packets because a routing policy can be installed appropriately in accordance with the current presence status of each user terminal. Also, the invention can eliminate the need for manual installation of routing policies for each router.

What is claimed is:

1. A presence-base packet routing control apparatus for selectively installing a routing policy appropriate for user terminal's presence status in a router which is connected to a communication network and has the function of policy routing of received packets, said apparatus comprising:
a presence information management data base for storing presence status information for each user terminal;
a presence policy management data base for storing routing policies to be applied for the user terminal in association with possible presence statuses of a user terminal and;
a presence information analyzing unit for translating presence information notified from a user terminal into presence status information and updating said presence information management data base, as required, according to the presence status information; and
a presence-base routing policy control unit for determining a routing policy to be installed in a particular router to which said user terminal is connected, based on the presence status of said user terminal output from said presence information analyzing unit and information stored in said presence policy management data base.

2. The presence-base packet routing control apparatus according to claim 1, further comprising:
a router control unit for creating a routing policy installation command based on the routing policy determined by said presence-base routing policy control unit, and transmitting the routing policy installation command to the particular router to which said user terminal is connected.

3. The presence-base packet routing control apparatus according to claim 2, further comprising:
a router information management data base for storing management information for each router, wherein
said router control unit determines said particular router to which said routing policy installation command is to be transmitted, by referring to said router information management data base.

4. The presence-base packet routing control apparatus according to claim 1, wherein said presence information analyzing unit compares the user terminal's presence status information translated from said presence information with the previous presence status information of the user terminal stored in said presence information management data base and outputs a new presence status to the presence-base packet routing policy control unit when the presence status has changed.

5. The presence-base packet routing control apparatus according to claim 1, wherein at least one of the routing policies stored in said presence policy management data base includes connection information for designating a network to which packets received from said user terminal should be transmitted.

6. The presence-base packet routing control apparatus according to claim 1, wherein at least one of the routing policies stored in said presence policy management data base includes information specifying a routing priority to be given to packets received from said user terminal.

7. The presence-base packet routing control apparatus according to claim 1, wherein at least one of the routing policies stored in said presence policy management data base specifies the attribute of data to be included in packets received from said user terminal.

8. The presence-base packet routing control apparatus according to claim 1, wherein at least one of the routing policies stored in said presence policy management data base specifies a source IP address, a destination IP address, and a source port number to be included in a header of each packet received from said user terminal.

9. A packet routing control method for selectively installing a routing policy appropriate for user terminal's presence status in a router which is connected to a communication network and has the function of policy routing of received packets, said packet routing control method comprising the steps of:
transmitting from a user terminal to a packet routing control apparatus a message specifying presence information of the user terminal;
analyzing by said packet routing control apparatus, the presence information specified in the message received and determining user terminal's presence status;
determining by said packet routing control apparatus according to the presence status of said user terminal, a routing policy to be applied for packets received from said user terminal;
creating by said packet routing control apparatus, a routing policy installation command for the determined routing policy and transmitting the command to a particular router to which said user terminal is connected; and
changing by said particular router, routing conditions to be applied for packets received from said user terminal according to the routing policy installation command.

10. The packet routing control method according to claim 9, wherein said user presence information includes user terminal's location information.

11. The packet routing control method according to claim 9, wherein said user presence information includes information specifying the user terminal operation mode.

12. The packet routing control method according to claim 9, wherein the routing policy installation command designates connection information for specifying a network to which packets received from said user terminal should be transmitted.

13. The packet routing control method according to claim 9, wherein the routing policy installation command specifies information representing a routing priority to be given to packets received from said user terminal.

14. The packet routing control method according to claim 9, wherein the routing policy installation command specifies the attribute of data to be included in packets received from said user terminal.

15. The packet routing control method according to claim 9, wherein the routing policy installation command specifies a source IP address, a destination IP address, and a source port number to be included in a header of each packet received from said user terminal.
